(19) United States
(12) Patent Application Publication
(10) Pub. No.: US 2011/0088448 A1
(43) Pub. Date: Apr. 21, 2011

(54) INSTRUMENT FOR CALIBRATING AN ALTIMETRIC DEVICE

(75) Inventor: Michel Willemin, Preles (CH)

(73) Assignee: EM MICROELECTRONIC-MARIN SA, Marin (CH)

(21) Appl. No.: 12/999,496

(22) PCT Filed: Jun. 11, 2009
(86) PCT No.: PCT/EP09/57243

§ 371 Date: Dec. 16, 2010

(30) Foreign Application Priority Data
Jun. 16, 2008 (EP) 08158353.6

(51) Int. Cl. G01C 25/00

(52) U.S. Cl. 73/1.79

(57) ABSTRACT

Calibration instrument for an altimetric device delivering an indication of the altitude of the location where it is located on the basis of an atmospheric pressure measurement, characterized in that it includes means for transmitting a signal carrying data representative of the altitude at which it is placed. The invention also concerns a device delivering an indication of the altitude of the place where it is located on the basis of an atmospheric pressure measurement and a calibration system including a calibration instrument and an altimetric device.

The present invention concerns an instrument for calibrating an altimetric device. More specifically, the present invention concerns an instrument for automatically calibrating a device that supplies the user thereof with an altimetric indication on the basis of atmospheric pressure.

Various devices exist on the market that indicate to users thereof the altitude of the place where they are located. The watch marketed by the Swiss watch company Tissot under the trademark T-Touch may be cited by way of example. Simply by touching a touch sensitive key, the person wearing a Tissot watch can immediately discover the altitude at which he or she is located. However, the drawback of the Tissot watch, just like other altimetric devices, lies in the fact that the altimetric indication is determined on the basis of atmospheric pressure, which is subject to both temporal and geographical variations. Consequently, if the atmospheric pressure of the place where the user of the altimetric device is located changes, the altimetric reading given by said altimetric device will fluctuate. If the user knows the exact altitude of the place where he is located, he can recalibrate the altimetric device. Otherwise, the user has to consult a road map, the internet or any other source of information to discover the altitude of his location. Once in possession of this information, he can recalibrate the altimetric device. However, for most altimetric devices, the recalibrating step requires a series of quite complex operations, which makes recalibration tedious for the user.

The satellite positioning system known as the Global Positioning System, or GPS, is now commonly used, for example, to identify the position of a motor vehicle on the Earth's surface. The same will soon be true of the European system Galileo. There are cases where the GPS system has to use altitude data to be able to determine the position of an object. This is typically the case when the topology is not univocal, i.e. when different altitudes correspond to the same point on the globe. Let us imagine a place in a town surrounded by skyscrapers which reflect satellite signals or even an interlaced arrangement of motorways in an urban landscape. It is not unusual in various locations for one portion of a motorway to straddle another. In order to be able to determine which portion of motorway the automobile vehicle is on, the GPS system must therefore know the precise altitude of said vehicle. The GPS system is more accurate horizontally than vertically. This is why it is common to fit GPS systems with a system for determining altitude. However, these systems for determining altitude are based on atmospheric pressure measurement. In order for them to be able to supply the GPS system with a reliable altitude reading, they must be periodically recalibrated. To the Applicant's knowledge, no means exist for automatically recalibrating an altimetric device and it is thus up to the user to perform this operation manually.

It is an object of the present invention to overcome the aforementioned drawbacks in addition to others by providing an instrument that automatically calibrates an altimetric device.

The present invention therefore concerns a system for calibrating an altimetric device, said altimetric device including means for delivering an indication of the altitude of the place where it is located, on the basis of an atmospheric pressure measurement, characterized in that it includes a calibration instrument which transmits a signal carrying data representative of the altitude at which said calibrating instrument is situated, said signal being detected by the altimetric device which uses the altitude data for recalibrating the means delivering the altitude indication.

The present invention also concerns a calibrating instrument for an altimetric device delivering an indication of the altitude of the place where it is located, on the basis of an atmospheric pressure measurement, characterized in that it includes means for transmitting a signal carrying data representative of the altitude at which it is placed.

The present invention also concerns an altimetric device including means for delivering an indication of the altitude of the place where it is located on the basis of an atmospheric pressure measurement, characterized in that it further includes means for receiving a signal carrying data relating to the altitude of the place where it is located and for using this data to reset the altitude determining means thereof.

Owing to these features, the present invention provides a system that can automatically recalibrate an altimetric device supplying the user thereof with an indication of the altitude at which he is located, on the basis of an atmospheric pressure measurement. Indeed, the calibration instrument transmits a signal carrying data relating to the altitude of the location where it is set up. This altitude is determined at the time when the calibration instrument is set up and is not inclined to change since said calibration instrument is intended to remain permanently at the location where it has been placed. Consequently, when the user passes in proximity to the calibration instrument with his altimetric device, the altimetric device picks up the signal transmitted by the calibration instrument and uses the altitude representative data carried by said signal to reset the altitude determining means.

Multiple calibration instruments can be placed at any conceivable location. In the home, for example, the calibration instrument can be set up in the garage, so that the altimetric device associated with the GPS system of the motor vehicle will be recalibrated each time that the vehicle enters the garage. The calibration instrument can also be placed, for example, on a bedside table if the altitude determining device is integrated in a wristwatch. The altimetric device will thus be reset each evening when the wearer places his watch on the bedside table.

In the case of domestic applications (office, house, garage, etc.) one may envisage the calibration instrument transmitting its calibration signal at a low frequency, for example once every fifteen minutes, for a millisecond each time. Conversely, in busy places (restaurants, hotels, campsites, etc.) or even along roads, one may envisage the calibration instrument transmitting the calibration signal at a high frequency, for example once every two or three seconds, for a millisecond each time.

The calibration instrument is a low power consuming device. Powered by a battery, it has a life of approximately one year. It includes a non volatile memory into which the altitude of the location where it is placed is programmed. It also includes means for transmitting a signal carrying altitude data. The signal may be a radio-frequency signal, an infra-red signal or even an ultrasonic signal. As regards the altimetric device, in addition to the means necessary for measuring atmospheric pressure, it must include means for receiving the signal transmitted by the instrument and for storing the received altitude data. Thus, depending upon the particular case, the altimetric device will include means for receiving a broadcast signal, an infra-red signal, an ultrasonic or other signal.

In the simplest variant, the altimetric device can include simple logic circuits which will implement an appropriate algorithm for replacing the calculated altitude value with the altitude value received from the calibration instrument. Of course, the altimetric device can also include a microcontroller circuit particularly when it is fitted with display means, for example a liquid crystal display, which will display the new altitude value transmitted by the calibration instrument according to the invention.

1-3. (canceled)

4. A calibration instrument for an altimetric device delivering an indication of the altitude of the location where it is located on the basis of an atmospheric pressure measurement, wherein it includes means for transmitting a signal carrying data representative of the altitude at which it is placed.

5. An altimetric device including means for delivering an indication of the altitude of the place where said device is located on the basis of an atmospheric pressure measurement, wherein it further includes means for receiving a signal carrying data relating to the altitude of the place where it is located and for using this data to reset the altitude determining means thereof.

6. A system for calibrating an altimetric device, said altimetric device including means for delivering an indication of the altitude of the place where said device is located, on the basis of an atmospheric pressure measurement, wherein it includes a calibration instrument which transmits a signal carrying data representative of the altitude at which said calibrating instrument is situated, said signal being detected by the altimetric device which uses the altitude data for recalibrating the means delivering the altitude indication.
